(19) United States
(12) Patent Application Publication
(10) Pub. No.: US 2008/0058041 A1
(43) Pub. Date: Mar. 6, 2008

(54) Guide and Agricultural Machine Incorporating Same

(76) Inventor: Laurence Colin Phillips, Merredin (AU)

Correspondence Address: KEVIN J. MCNEELY, ESQ., 5335 WISCONSON AVENUE, NW, SUITE 440, WASHINGTON, DC, 20015, US

(21) Appl. No.: 11/761,292

(22) Filed: Jun. 11, 2007

(30) Foreign Application Priority Data
Dec. 10, 2004 (AU) 2004907051
Dec. 9, 2005 (AU) PCT/AU2005/001869

(51) Int. Cl. A01F 12/10

(52) U.S. Cl. 460/70

(57) ABSTRACT

A guide arrangement for use in harvesting material. The guide arrangement a structure moveable around an endless path to present a downwardly directed guide face for the purpose of confronting and assisting with the movement of material being delivered to a delivery zone.

### FIELD OF THE INVENTION

The present invention relates to guides for use in agricultural machines, and claims priority for Australian provisional patent 2004907051.

Australian provisional patent 2004907051 is hereby fully incorporated by reference.

### BACKGROUND ART

In the field of combine harvesting, combine harvesters are often provided with removable headers, also known as false fronts. Standard removable headers for grain typically include a cross auger for pushing the cut crop into an intake for subsequent processing. In the case of wheat the cross auger is sometimes replaced by a fabric or rubber apron, so as to provide for more effective threshing by maintaining the orientation of the crop as it is introduced into the intake. Dummy headers are typically used in situations where a windrow of grain or other material has been cut before ripening, in preparation for harvesting. Often a tined pickup is used to raise the crop from the ground and deliver the crop into a delivery zone in front of the cross auger.

To prevent the crop continuing to move in an upward path from the pickup and bunching up in front of and above the auger, devices such as hold-downs are typically used. Such hold-downs are commonly comprised of arms formed from steel, fibreglass or plastic tubing that are held in a frame above the crop. In some cases a rotating beater is occasionally positioned to push the crop down in front of the auger so as to stop the crop from rising upwards.

It is against this background that the present invention has been developed.

### SUMMARY

According to a first aspect of the invention there is provided a guide arrangement for use in harvesting material comprising: a structure moveable around an endless path to present a downwardly directed guide face for the purpose of confronting and assisting with the movement of material being delivered to a delivery zone.

Preferably the guide includes means for retrofitting a harvesting header.

The guide may include a frame having a first end and a second end, with the structure comprising an endless belt that is mounted between the first and second end, so as to be moveable around the endless path.

In particular forms of the invention the endless belt comprises two spaced apart loops mounted between the first and second end of the frame, together with a plurality of rails that connect the loops by extending therebetween. For this reason the guide may be termed a moving rail hold down.

Preferably the frame includes means for adjusting the spacing between the first and second ends. In this manner the tension of the endless belt can be selected, and/or different lengths of endless belt can be used.

The frame may include first and second sprockets respectively located at the first and second end of the frame. At least one of the sprockets may be advantageously configured to drive the structure around the endless path at a selected speed. An electrical controller may monitor the ground speed of the vehicle to determine and select the speed of the sprocket.

Preferably the guide includes means for coupling the at least one of the sprockets to a drive means. The drive means may be mounted to the frame and be provided in the form of a hydraulic motor.

Preferably the first end of the frame is at a higher elevation than the second end of the frame, relative to the movement of material being delivered to the delivery zone, so as to cause the structure to compress the material during the delivery thereof.

The guide may be retrofitted onto existing machines such as headers for picking up and delivering material to harvesters, as well as comprising the machine or header itself.

Preferably the guide arrangement includes a pickup structure movable to present a upwardly directed guide face, opposite the downwardly directed guide face of the guide arrangement, for supporting and conveying material along a delivery path towards the delivery zone whilst the downward directed guide face confronts and assists with the movement of material.

According to a second aspect of the invention there is provided a guide arrangement for use in harvesting material comprising:
a first structure movable to present a upwardly directed guide face for supporting and conveying material along a delivery path towards a delivery zone;
a second structure positioned above the first structure and moveable around an endless path to present a downwardly directed guide face for the purpose of confronting and assisting the movement of material being delivered to the delivery zone.

The first structure may be provided in the form of a pickup belt having flexible teeth and thus may be adapted to lift the material up from the ground.

According to a third aspect of the invention there is provided a guide arrangement for use in harvesting material comprising:
a receptacle defining a delivery zone;
a first structure movable to present a delivery face for supporting and conveying material along a delivery path towards the delivery zone;
a second structure positioned above the first structure and moveable around an endless path to present a downwardly directed moving guide face for the purpose of confronting the material being delivered to the delivery zone;
transfer means arranged to transfer the material from the delivery zone to an intake.

The transfer means may comprise an auger disposed between the delivery zone and the intake. In arrangements of this type the auger may include retractable fingers as are known in the agricultural industry.

The material may be suitable for threshing and separating and the guide may include a broad elevator.

It is considered that the present invention will be particularly useful with canola crops and the like.

Further insight into the advantages and characteristics of the present invention can be gained from the following description of a preferred embodiment and the accompanying drawings.

### BRIEF DESCRIPTION OF THE DRAWINGS

The invention will be better understood by reference to the following description of a specific embodiment thereof, as shown in the accompanying drawings in which:

FIG. 1 is a perspective view of a machine according to a first embodiment of the invention;

FIG. 2 is a schematic sectional view of the machine shown in FIG. 1;

FIG. 3 is a plan view of the machine shown in FIG. 1; and

FIG. 4 is a side view of the machine shown in FIG. 1; and

FIG. 5 is a schematic plan view of a frame used in the machine shown in FIG. 1.

### DETAILED DESCRIPTION

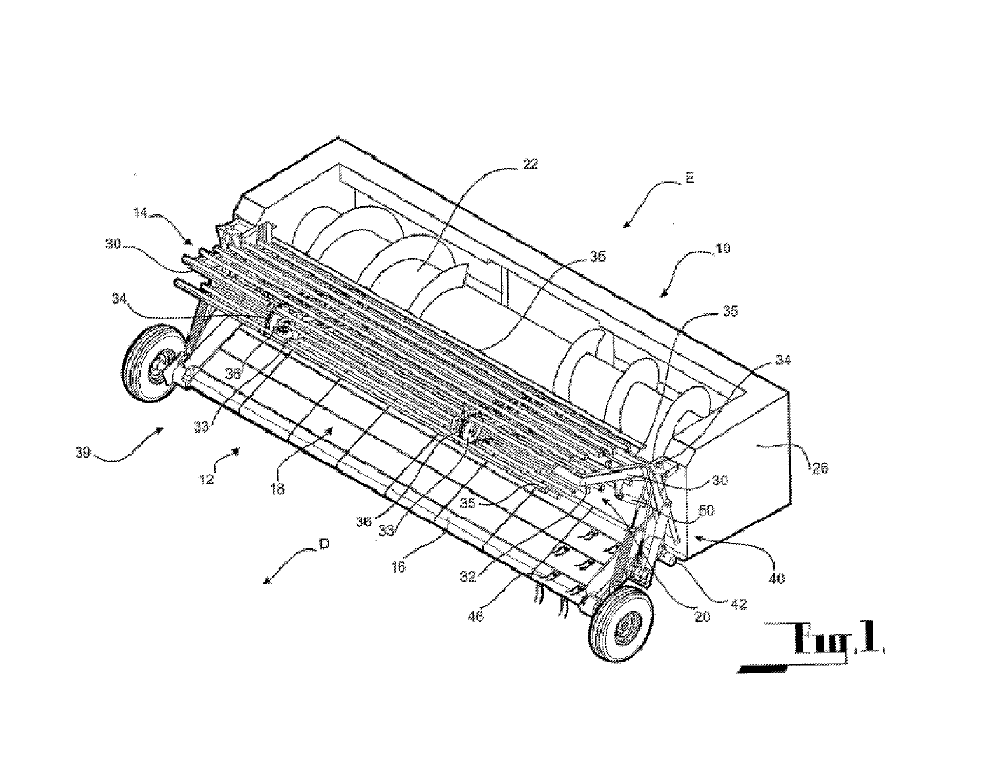

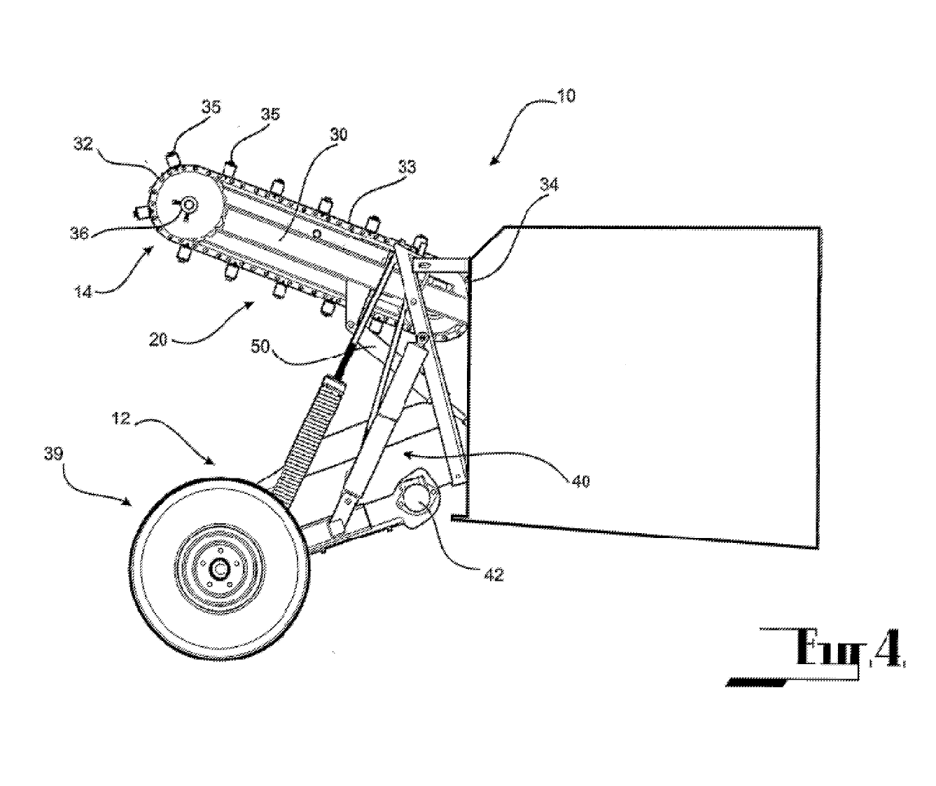

Referring to FIGS. 1 to 5 there is shown a machine 10 in accordance with a preferred embodiment of the invention. The machine 10 is able to advantageously pickup crop more efficiently.

The machine 10 includes a first structure 12 and a second structure 14. The first structure 12 is moveable relative to the machine 10 to present a delivery face 16 for supporting and conveying the crop along a delivery path to a delivery zone 18.

The second structure 14 is positioned above the first structure 12 so as to confront and compress the crop as it is delivered to the delivery zone 18. Moreover, the second structure 14 is moveable around an oblong endless path to present a downwardly directed moving guide face 20. The guide face 20 serves the purpose of confronting the crop while it is being delivered to the delivery zone 18. The structure 14 is arranged to move in a counter clockwise direction while the structure 12 is arranged to move in a clockwise direction. In this manner both of the structures 12, 14 assist with the movement of the crop.

In the machine 10 a transfer means in the form of a cross auger 22 is disposed between the delivery zone 18 and the throat 24 of an intake 26. The intake 26 is provided in the form of a harvester broad elevator for subsequent threshing and separation of the crop. While not shown in the drawings a driver is located in a cab of the machine above the intake 26.

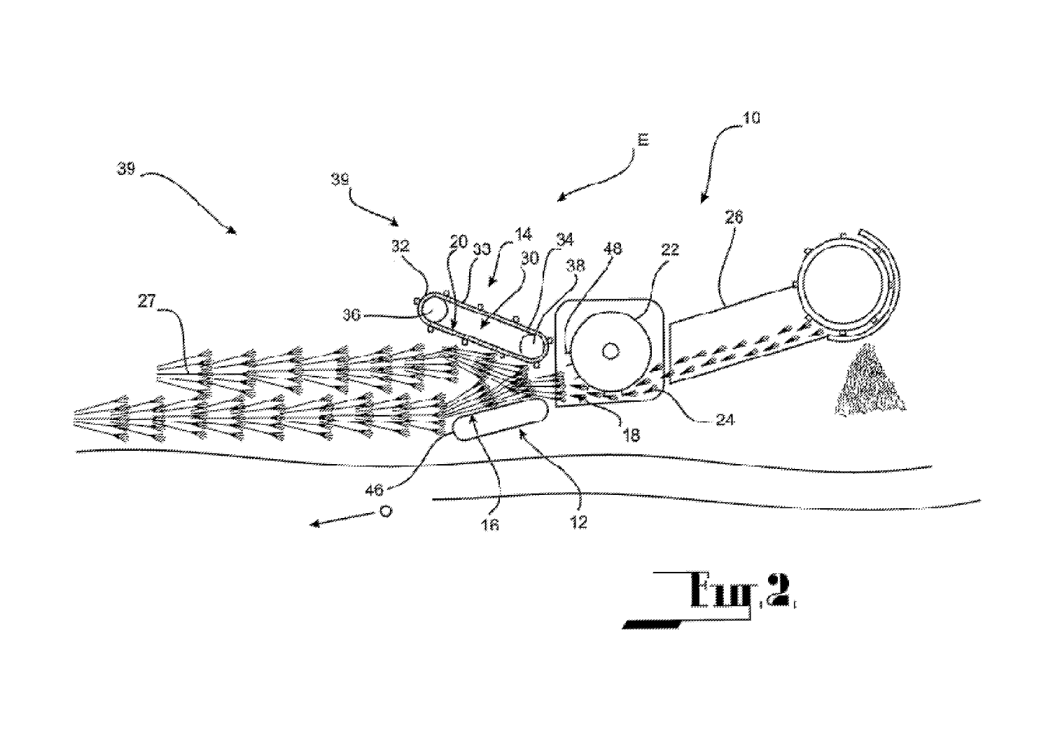

With this arrangement the machine 10 moves relative to the ground in a direction generally designated D in FIGS. 1 and 2. As shown in FIG. 1 the machine 10 picks up the crop from a conventional window 27 into which it has been swathed.

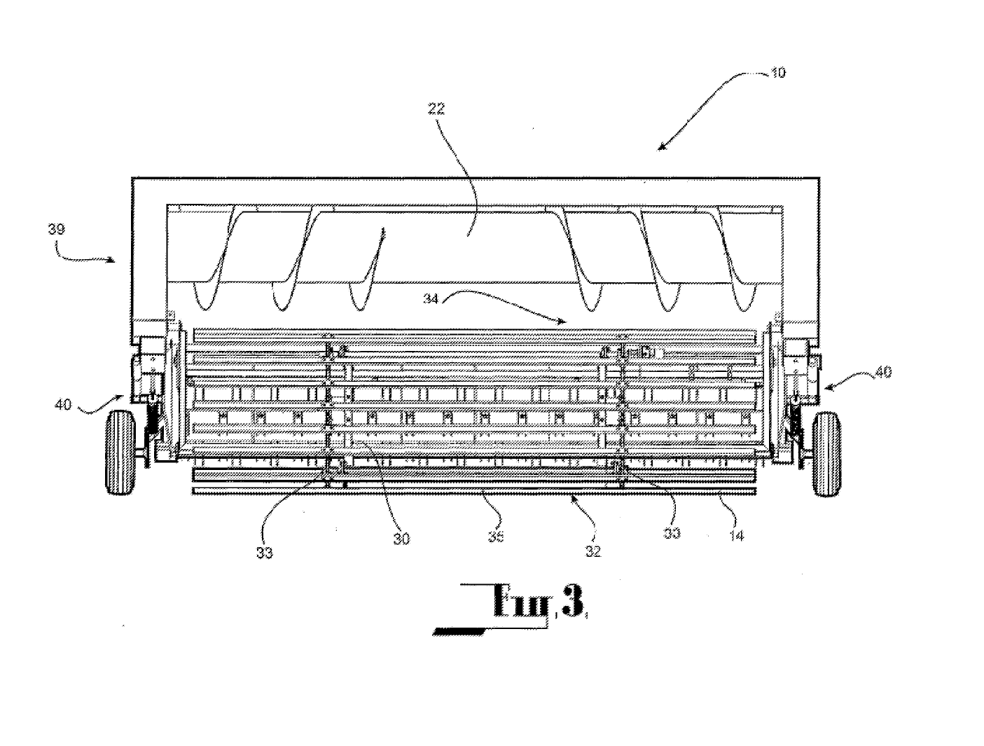

The second structure 14 is supported by a frame 30 which includes a first end 32 and a second end 34. As is shown in FIG. 3 the frame includes a first pair of sprockets 36, at the first end 32 of the frame 30, and a second pair of sprockets 38, at the second end of 34 of the frame 30.

The structure 14 comprises two spaced apart chains 33 that are mounted to the sprockets 36, 38 so as to be aligned in a plane containing the direction D. The structure 14 further includes a plurality of rails 35 that extend between the chains 33 so as to connect the two chains 33 together and form and endless belt. In this embodiment the rails 35 are made form steel however in other embodiments the rails 35 may be made from fibreglass, plastic tubing or other suitable material.

The rails 35 are spaced apart along the structure 13 such that there is a line of sight along the direction generally designated E in FIGS. 1 and 2 allowing the driver located in the cab to observe the feeding of material through the machine 10. The machine 10 forms part of a header 39.

The frame 30 includes means 40 for adjusting the spacing between the first and second ends 32, 34 of the frame. By using the means 40, belts of different lengths can be used with the machine 10 and/or different tensions can be applied thereto.

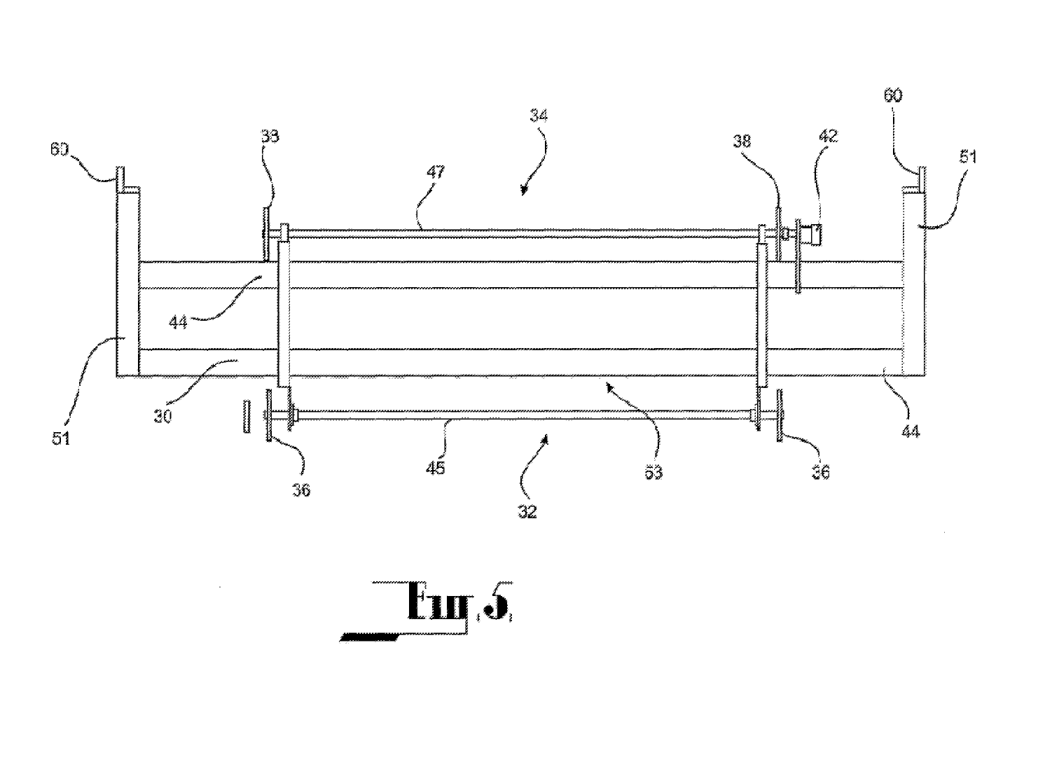

The second pair of sprockets 38 are configured to drive the structure 14 around the frame 30 by having the sprockets 38 coupled to a hydraulic motor 42. This is shown schematically in FIG. 5. With the use of the motor 42 the structure 14 can be driven around the frame 30 at any one of a number of predetermined speeds.

Each of the sprockets 36, 38 and motor 42 is connected to one of two beams 44 for strength and rigidity. As is also shown in FIG. 1 the two beams 44 are connected to two arms 51 to form a rigid frame 53.

The first pair of sprockets 36 are connected by a rod and bearing system 45 so that they are constrained to rotate at the same speed. A similar rod and bearing system 47 connects the sprockets 38 so that they also rotate at the same speed whilst being driven by the motor 42. As would be apparent the spacing of the individual loops in the chains 33 ensure that both pairs of sockets 36 and 38 operate in concert.

As can be seen from FIG. 1 the first end 32 of the frame 30 is at a higher elevation than the second end 34 of the frame 30. As a result the structure 14 operates to compress the crop as the crop is conveyed along the structure 14 to the delivery zone 18. This provides the particular advantage of the crop not being propelled by the structure 12 so as to continue an upward path and bunch up in front of the auger 22. The downwardly directed guide face 20 of the structure 14 confronts the crop and assists with the movement of the crop to the delivery zone 18. The machine is therefore able to travel at relatively high speeds, and also pickup the crop at a relatively high rate.

As is apparent from the Figures the structure 12 is provided in the form of a pickup belt having a plurality of flexible tines or plastic teeth 46. The pickup belt 12 in this embodiment comprises eight individual belts and is therefore eight belts wide. The auger 22 includes retractable fingers 48 that propel the crop toward the throat 24 of the intake 26.

The motor 42 is mechanically coupled to the pickup belt 12 so that the speed of the machine 10 in direction D is matched by the pickup 12. Thus the crop is raised and delivered towards the delivery zone 18 in the most gentle of manners. This prevents seed loss.

In the same manner the motor 42 drives the structure 12 such that the rails 35 push down on the crop in a very gradual and gentle manner. This generates a more positive feed with undue shedding of seed.

A pair of hydraulic arms 50 is disposed along the arms 51 to allow the driver to change the angle of inclination of the frame 53. The frame 53 is pivotally connected at locations 60 for this purpose.

It will be understood that various changes may be made to the form, details, arrangement and proportion of the various parts and steps without departing form the spirit and scope of the invention. Modifications and variations such as would be apparent to the skilled addressee are, at the very least, considered to fall within the scope of the present invention.

For example in other arrangements the speeds of the structures 12 and 14 are electronically synchronised with the speed of the other, and also the machine 10.

Throughout the specification, unless the context requires otherwise, the word “comprise” or variations such as “comprises” or “comprising”, will be understood to imply the inclusion of a stated integer or group of integers but not the exclusion of any other integer or group of integers.

1. A guide arrangement for use in harvesting material comprising: a structure moveable around an endless path to present a downwardly directed guide face for the purpose of confronting and assisting with the movement of material being delivered to a delivery zone.

2. A guide arrangement as claimed in claim 1 wherein the guide includes means for retrofitting a harvesting header.

3. A guide arrangement as claimed in claim 1 including a frame having a first end and a second end with the structure comprising an endless belt that is mounted between the first and second end, so as to be moveable around the endless path.

4. A guide arrangement as claimed in claim 3 wherein the endless belt comprises two spaced apart loops mounted between the first and second end of the frame, together with a plurality of rails that connect the loops by extending therebetween.

5. A guide arrangement as claimed in claim 3 wherein the frame includes means for adjusting the spacing between the first and second ends to allow the tension of the endless belt to be selected.

6. A guide arrangement as claimed in claim 3 wherein the frame includes first and second sprockets respectively located at the first and second end of the frame.

7. A guide arrangement as claimed in claim 6 wherein at least one of the sprockets is configured to drive the structure around the endless path at a selected speed.

8. A guide arrangement as claimed in claim 7 including an electrical controller adapted to monitor the ground speed of the guide for use in selecting the speed.

9. A guide arrangement as claimed in claim 6 including means for coupling the at least one of the sprockets to a drive means.

10. A guide arrangement as claimed in claim 3 wherein the first end of the frame is at a higher elevation than the second end of the frame, relative to the movement of material being delivered to the delivery zone, so as to cause the structure to compress the material during the delivery thereof.

11. A guide arrangement as claimed in claim 1 including a pickup structure movable to present a upwardly directed guide face, opposite the downwardly directed guide face of the guide arrangement, for supporting and conveying material along a delivery path towards the delivery zone whilst the downward directed guide face confronts and assists with the movement of material.

12. A guide arrangement for use in harvesting material comprising:
a first structure movable to present a upwardly directed guide face for supporting and conveying material along a delivery path towards a delivery zone;
a second structure positioned above the first structure and moveable around an endless path to present a downwardly directed guide face for the purpose of confronting and assisting the movement of material being delivered to the delivery zone.

13. A guide arrangement for use in harvesting material as claimed in claim 12 wherein the first structure is adapted to lift the material up from the ground.

14. A guide arrangement as claimed in claim 12 wherein the first structure is a conventional pickup assembly.

15. A guide arrangement for use in harvesting material comprising:
a receptacle defining a delivery zone;
a first structure movable to present a delivery face for supporting and conveying material along a delivery path towards the delivery zone;
a second structure positioned above the first structure and moveable around an endless path to present a downwardly directed moving guide face for the purpose of confronting the material being delivered to the delivery zone;
transfer means arranged to transfer the material from the delivery zone to an intake.

16. A guide arrangement as claimed in claim 15 wherein the transfer means comprises an auger disposed between the delivery zone and the intake.

17. A guide arrangement as claimed in claim 15 wherein the guide arrangement includes a broad elevator.
